(19) United States
(12) Patent Application Publication
(10) Pub. No.: US 2015/0144010 A1
(43) Pub. Date: May 28, 2015

(54) ROTISSERIE ACCESSORY KIT

(71) Applicant: Aubrey Blake Carson, Memphis, TN (US)

(72) Inventor: Aubrey Blake Carson, Memphis, TN (US)

(21) Appl. No.: 14/536,613

(22) Filed: Nov. 8, 2014

Related U.S. Application Data
(60) Provisional application No. 61/909,805, filed on Nov. 27, 2013.

(51) Int. Cl. A47J 37/04

(52) U.S. Cl. CPC A47J 37/041
USPC 99/421 R

(57) ABSTRACT

The present invention is, multi-spit accessory conversion kit intended to be used for multiple types of barbecue grills and pits. The kits multiple skewer assembly is capable of being adjusted to various sized grills. The skewers are also able to easily be placed and removed from the multi-functional rotating rotisseries to control cooking.

This application claims benefit of and priority to U.S. Provisional Application No. 61/909,805, filed Nov. 27, 2013, by Aubrey Blake Carson, and is entitled to that filing date for priority. The specification, figures and complete disclosure of U.S. Provisional Application No. 61/909,805 are incorporated herein by the specific reference for all purposes.

### FIELD OF INVENTION

This invention relates to a multi-rotisserie accessory kit intended to be used for multiple types of barbecue grills and pits.

### BACKGROUND AND SUMMARY OF THE INVENTION

The invention relates to a device for cooking food, primarily barbeque, using a rotisserie. More specifically, the rotisserie cooking device comprises a frame for securing a plurality of skewers. The skewers are rotated by a motor connected to the frame. In operation, the frame size can be adjusted to suit a variety of different sized grills. Conventional barbecue grills are limited in that they only utilize a square inch cooking surface which greatly limits the amount of food possible to cook at one time. Conventional assemblies also constantly require the grill user to monitor the grill regularly in order to prevent over cooking and flare-ups that are caused when grilling a stationary piece of meat over a heat source. This limited cooking surface and flare-up leaves the barbecue consumer disappointed and frustrated due to the limited capabilities of a conventional grill.

The present invention or the multi-spit accessory kit assembly retrofits to conventional gas, charcoal, electric, pellet grills, fire pits, smokers allowing the device to enhance to a cubic inch cooking volume instead of a square inch cooking surface. Given that the invention, is a fully-functional multi-rotisserie assembly, it allows the grill user to benefit from the self-basting and flare-up preventing nature that rotating meat around heat produces.

The claimed invention differs from what currently exists in that it is a kit that can easily be placed on and removed from most any grill allowing said grills the benefits of cubic cooking volume instead of square inch cooking surface which enables most conventional and non-conventional grills to cook with more variety and more quantity that currently is offered by the grilling market. Given that it is a multiple rotisserie assembly no flipping of the meat, fruit or vegetables is required which also allows for the cook to spend more time with their family and friends.

Other devices do not work well because they are not capable of utilizing the entire cooking volume of a conventional grilling space just the cooking surface. A conventional grill traps the heat around the meat like an oven would bake a cake. Having a stationary piece of meat will inevitably loose the battle with gravity and dry out fairly quickly.

The stated embodiment improves on this because it is capable of using the entire cooking volume space of a conventional grill and because all the food is constantly rotating on the kit, it is in essence utilizing gravity instead of fighting against it. By being able to place this multi-spit rotisserie kit on multiple types of grills, this opens the door for many grillers of all skill levels to have access to and greatly benefit from this new technology.

### THE DRAWINGS

FIG. 1 is a perspective view of the device embodying the invention.

FIG. 2 is a side view of the device shown in FIG. 1.

FIG. 3 is a top view of the device shown in FIG. 1.

FIG. 4 is a front view of the device shown in FIG. 1.

FIG. 5 is an exploded perspective view of the device.

FIG. 6 is a perspective view of a skewer assembly.

FIG. 7 is an exploded perspective view of the device illustrating the motor assembly.

FIG. 8 is a side view of the device shown in FIG. 1 in a first position.

FIG. 9 is a side view of the device shown in FIG. 1 in a second position.

### DESCRIPTION OF A PREFERRED EMBODIMENT OF THE INVENTION

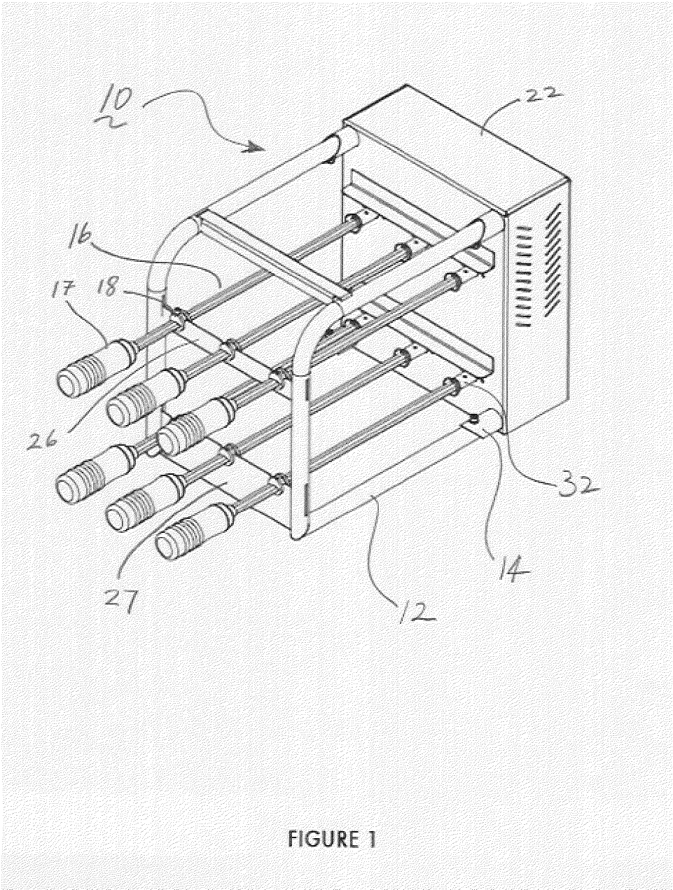

FIG. 1 is a perspective view of the invention. Specifically, a device 10 comprises a front housing 12 and a back housing 14. The back housing 14 has a motor housing 22 connected thereto. Front housing 12 has a top skewer support 26 and a bottom skewer support 26 and a bottom skewer support 27. A plurality of skewer 16 are connected to skewer supports 26 and 27 at one end and to a plurality of rotators 32 at the other end of skewers 16. The skewers 16 have handles 17 for manual manipulation. In its preferred embodiment, handles 17 are made of wood. Each skewer 16 has a support nut 18 for guiding and supporting each skewer 16. In its operation, skewer 16 is rotated by rotators 32 to controllably cook food attached to the skewers 16. Furthermore, each skewer 16 is easily manually engaged and re-engaged to control the rate of cooking for the, food on skewer 16. In its preferred embodiment, the skewer 16 cooking surfaced can be modified to suit the size of the heating source, such as a grill or stove top.

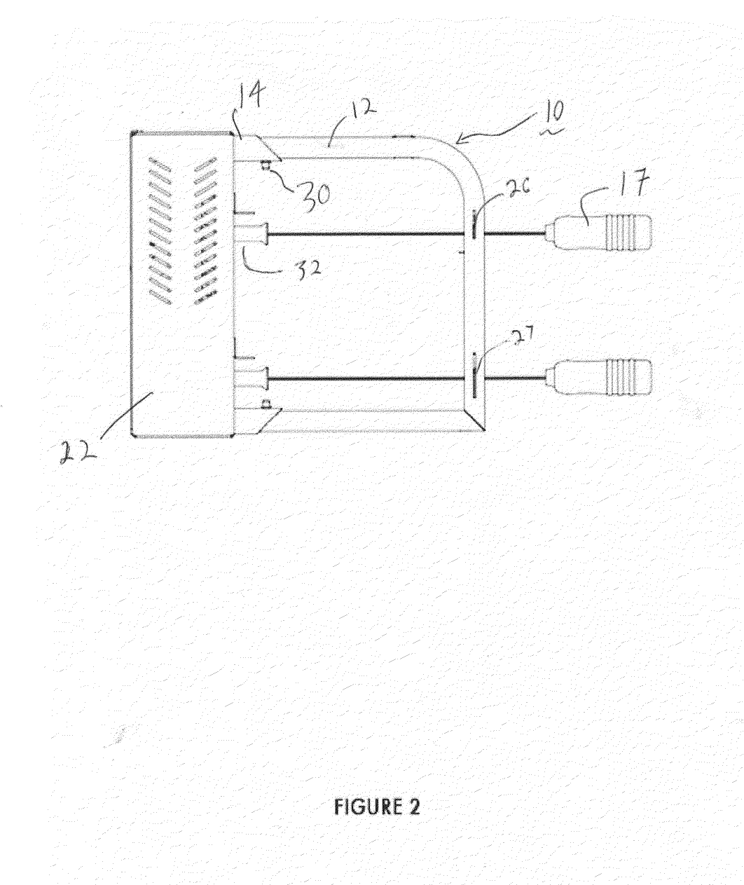

FIG. 2 is a side view of device 10. As can be seen, device 10 comprises motor housing 22 having back housing 14 connected thereto. Slidably connected to back housing 14 is front housing 12. Adjusting screw 30 is used to disengage and engage back housing 14 and front housing 12 together. Skewer 16 is connected to rotator 32 and skewer supports 26 and 27. Each skewer 16 has a handle 17 so that the skewer can be manually manipulated.

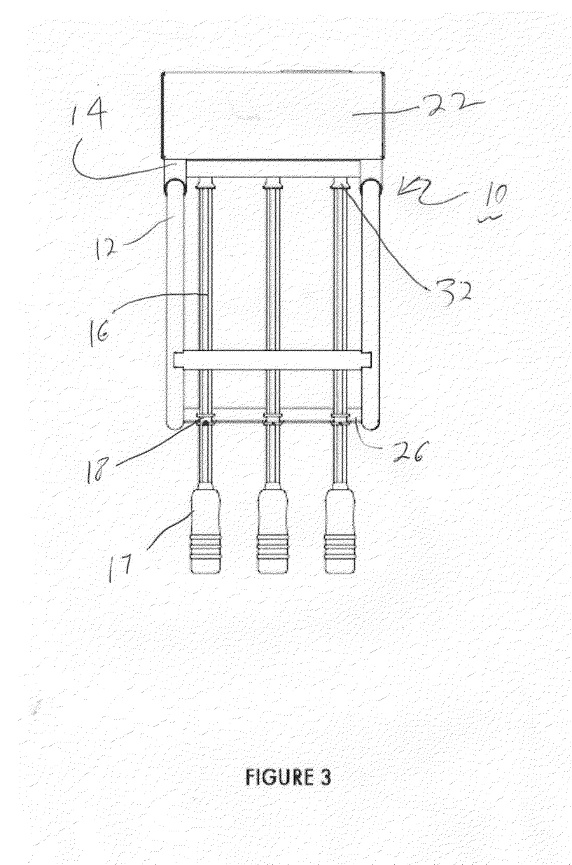

FIG. 3 is a top view of device 10. Device 10 has a motor housing 22 connected to back housing 14. Furthermore, back housing 14 is connected to front housing 12. Rotators 32 are connected to motor housing 22. Front housing 12 has top skewer support 26 connected to thereto to provide structural support for device 10 and to hold skewer 16. In operation, skewer 16 rotates about support nut 18 as rotator 32 moves in a circular motion. Furthermore, in operation, food is held by skewer 16 between rotator 32 and support nut 18. A feature of the inventions allows the distance between rotator 32 and support nut 18 to be adjusted. This feature permits device 10 to adapt to a plurality of cooking surfaces, whether it be commercial grills, outdoor camping grills or stove tops. Hence, the footprint of the device 10 can vary depending upon the size of the grill.

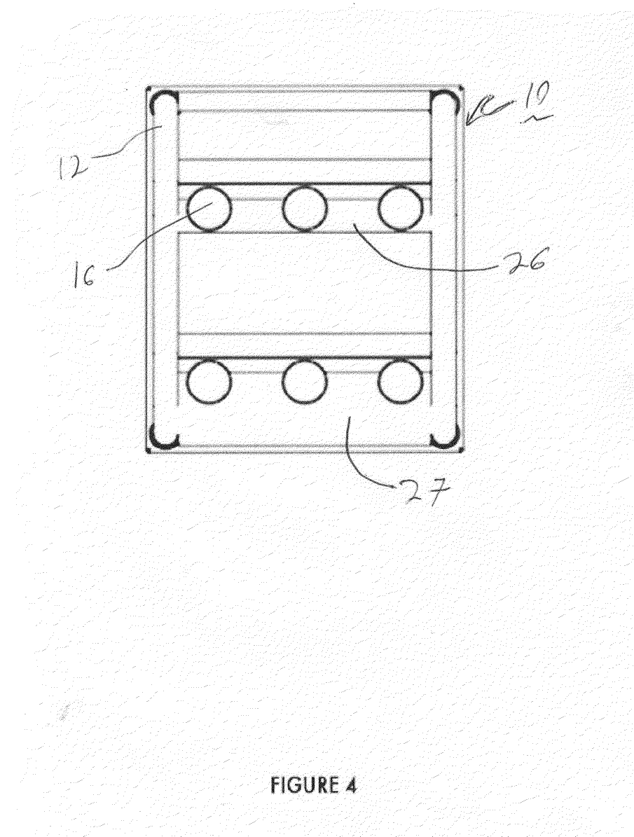

FIG. 4 is a front view of device 10. Front housing 12 has top skewer support 26 and bottom skewer support 27 connected thereto. The skewer support 26 and 27 provide structured support to device 10. Furthermore, skewer supports 26 and 27 are positioned to provide a plurality of cooking locations for device 10. In operation, skewers 16 can be relocated to any location to control cooking of food on the skewers 16.

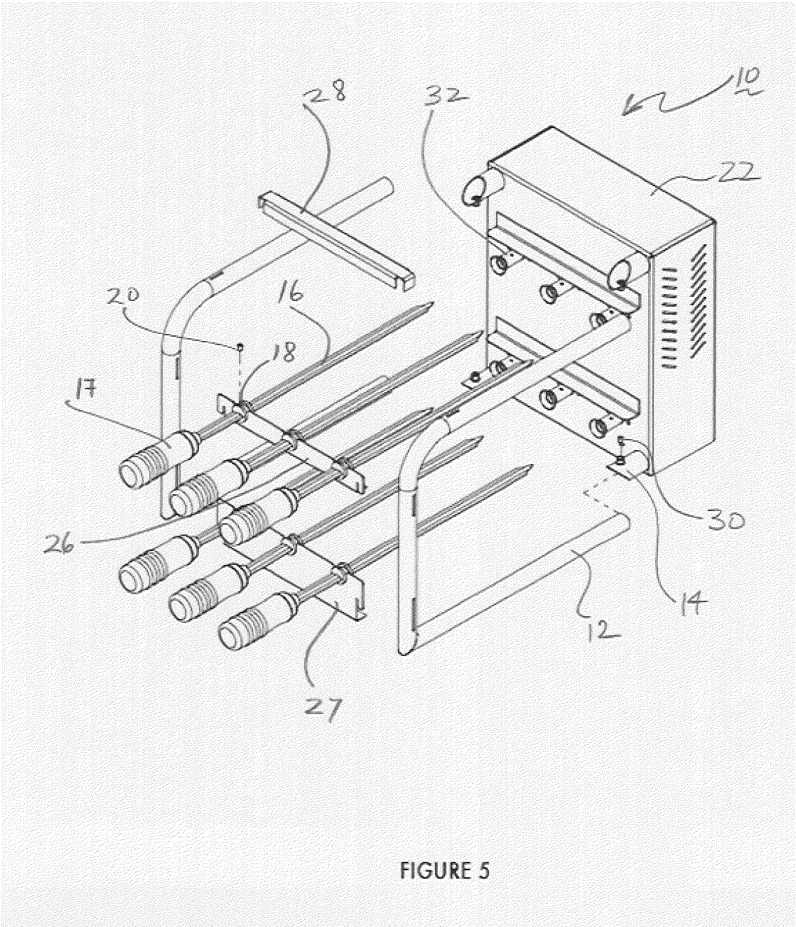

FIG. 5 illustrates the interconnect ability of device 10. Motor housing 22 has a plurality of rotators 32 connected thereto. Each rotator 32 is engageable with skewer 16. Motor housing 22 is connected to back housing 14. Front housing 12 is connected to back housing 14 by adjusting screw 30. A top support 28 is used to connect front housing 12 and to provide support for device 10. Furthermore, top skewer support 26 and bottom skewer support 27 are provided to structurally support front housing 12 and to provide a site to hold support nuts 18 for each skewer 16. The support nuts 18 are secured to skewer 16 by locking pin 20. Locking pin 20 can be one of many securing mechanisms such as a screw having an allen wrench head.

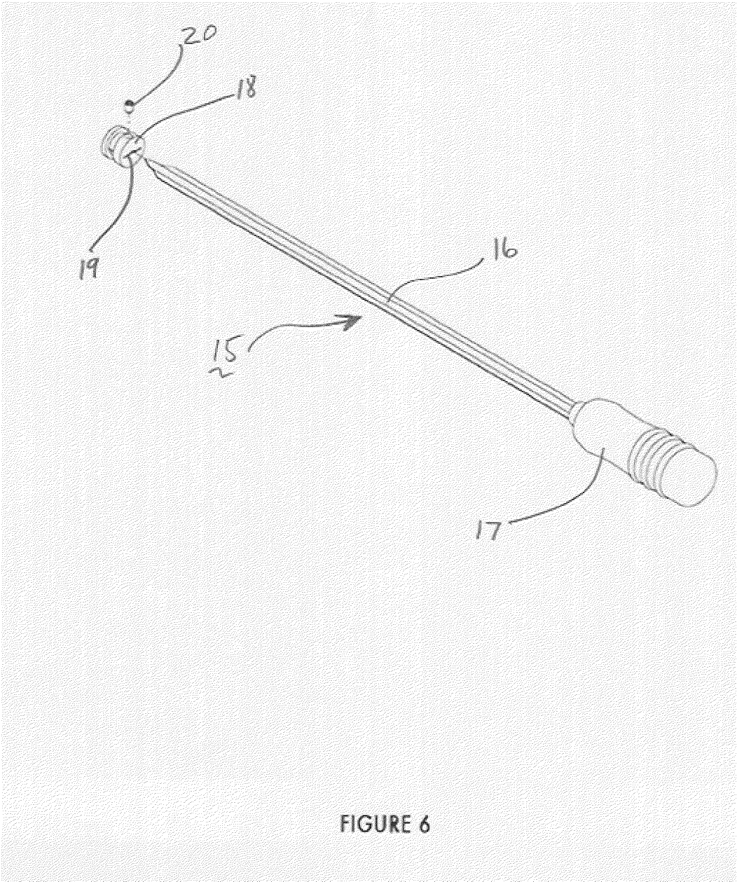

FIG. 6 is a skewer assembly 15 having skewer 16 connected to handle 17. Each skewer 16 has a support nut 18 with a slit 19. Slit 19 is configured to allow skewer 16 to slide through support nut 18. Locking pin 20 is screwably engaged to support nut 18 such that it engages and disengages support nut 18 to skewer 16 when tightened or loosened, respectively. Each skewer 16 has handle 17 connected thereto for manual manipulation. In operation, skewer 16 heats up during cooking, hence, handle 17 is provided of easy manipulation. Furthermore, skewer 16 is V-shaped and sharpened to allow for easy penetration into food being cooked.

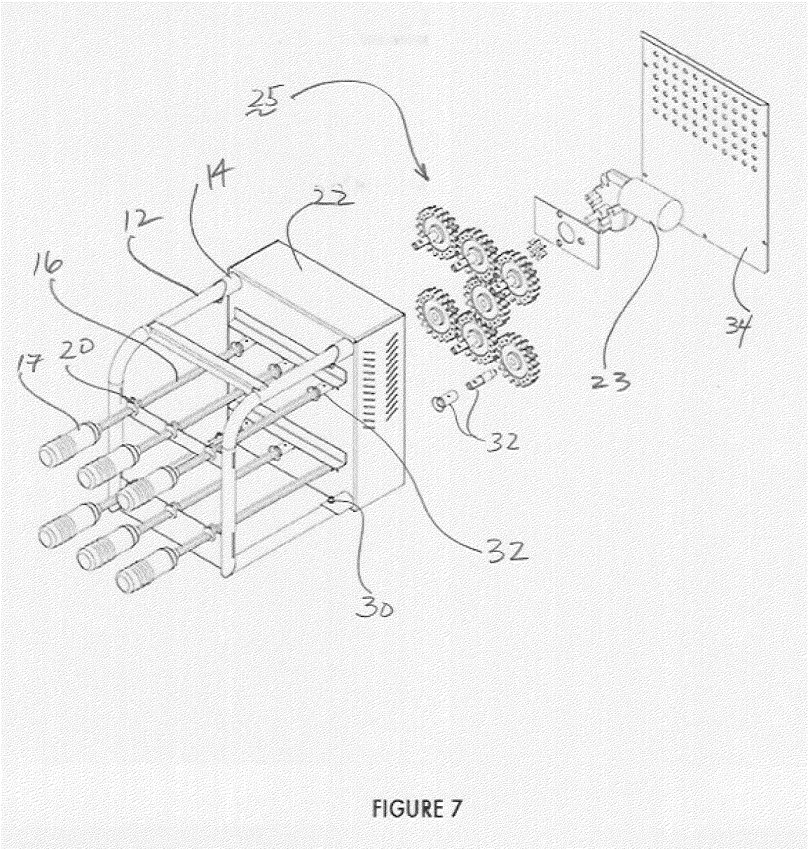

FIG. 7 is another exploded perspective view of device 10. This figure illustrates a motor assembly 25 having motor housing 22 with a back plate 34. Contained in motor housing 22 is a motor 23 connected to a plurality of gears 33. The operative gears 33 are connected to rotators 32. In operation, when motor 26 is rotated, gears 33 rotate each rotator 32. Thus, when cooking skewer 16 they are rotated by gears 33. As can be understood by one skilled in the art, the number of gears and connected skewers can vary. While the preferred embodiment features six rotatable skewers, the number can vary.

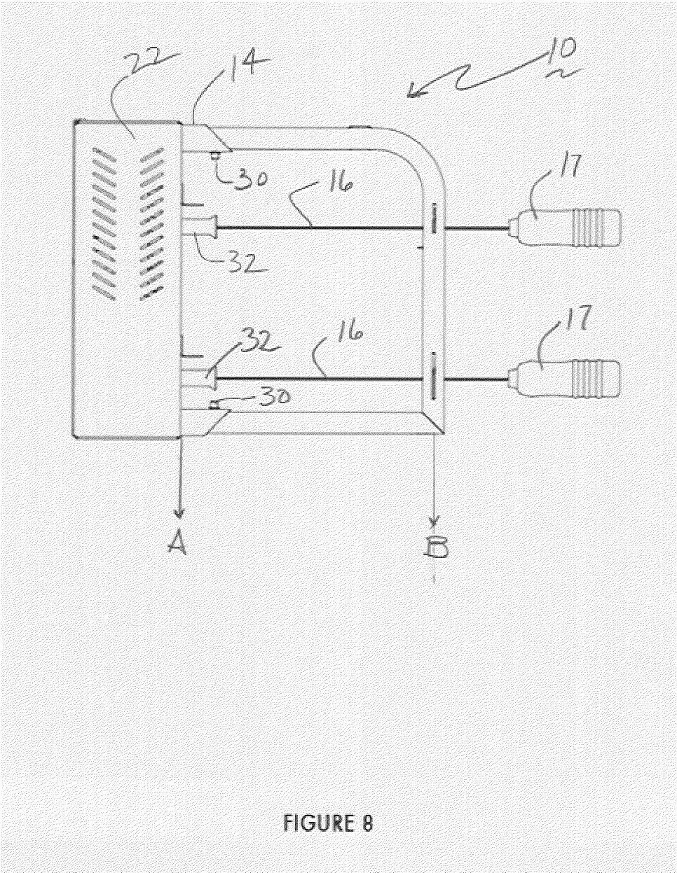

FIG. 8 is a side view of device 10 in a first position. In particular, the first position illustrates the device 10 such that point A and point B are a fix position. This fixed position is held in place by securing adjusting screw 30 which holds front housing 12 and back housing together.

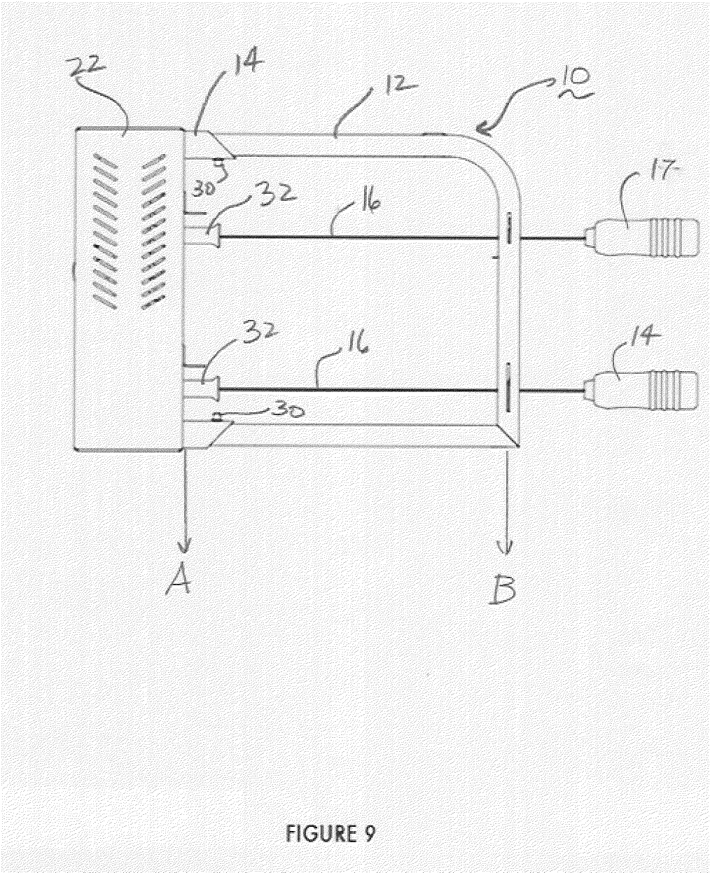

FIG. 9 is a side view of device 10 illustrating the distance between point A and point B at a second position. This is a unique feature of the invention. The ability to adjust the distance between point A and point B allows device 10 to adjust to a plurality of cooking surfaces. For example, the position illustrated in FIG. 8 may be used when cooking on a backyard grill. Alternatively, the position illustrated in FIG. 9 may be used when cooking at a camping grounds grill.

The invention relates to a device for cooking food, primarily barbeque, using a rotisserie. More specifically, the rotisserie cooking device comprises a frame for securing a plurality of skewers. The skewers are rotated by a motor connected to the frame. In operation, the frame size can be adjusted to suit a variety of different sized grills. Conventional barbecue grills are limited in that they only utilize a square inch cooking surface which greatly limits the amount of food possible to cook at one time. Conventional assemblies also constantly require the grill user to monitor the grill regularly in order to prevent over cooking and flare-ups that are caused when grilling a stationary piece of meat over a heat source. This limited cooking surface and flare-up leaves the barbecue consumer disappointed and frustrated clue to the limited capabilities of a conventional grill.

The present invention or the multi-spit accessory kit assembly retrofits to conventional gas, charcoal, electric, pellet grills, fire pits, smokers allowing the device to enhance to a cubic inch cooking volume instead of a square inch cooking surface. Given that the invention is a fully-functional multi-rotisserie assembly, it allows the grill user to benefit from the self-basting and flare-up preventing nature that rotating meat around heat produces.

The claimed invention differs from what currently exists in that it is a kit that can easily be placed on and removed from most any grill allowing said grills the benefits of cubic cooking volume, with two tiers of three automated rotisserie slots, and a third tier for resting and roasting foods, instead of square inch cooking surface which enables most conventional and non-conventional grills to cook with more variety and more quantity by as much as a factor of six, that currently is offered by the grilling market. Given that it is a multiple rotisserie assembly no flipping of the meat, fruit or vegetables is required which also allows for the cook to spend more time with their family and friends.

Other devices do not work well because they are not capable of utilizing the entire cooking volume of a conventional grilling space just the cooking surface. A conventional grill traps the heat around the meat like an oven would bake a cake. Having a stationary piece of meat will inevitably loose the battle with gravity and dry out fairly quickly.

The stated embodiment improves on this because it is capable of using the entire cooking volume space of a conventional grill and because all the food is constantly rotating on the kit, it is in essence utilizing gravity instead of fighting against it By being able to place this multi-spit rotisserie kit on multiple types of grills, this opens the door for many grillers of all skill levels to have access to and greatly benefit from this new technology.

What is claimed is:

1. A rotisserie cooking device for cooking food, comprising:
a frame having a first housing slidably connected to a second housing;
a plurality of skewers for holding said food, said skewers being held between said first housing and said second housing;
a motor assembly connected to said second housing, said motor assembly selectively connected to said skewers for rotating skewers; and
an adjusting screw for selectively engaging said first housing to said second housing to alter the size of said device.

2. The device of claim 1, where in a support nut is provided to adjust the amount of food being cooked on said skewer.

3. The device of claim 1, where in said support nut has a locking pin for screwably connecting said support nut to said skewer.

4. The device of claim 1, where in said skewer has a handle.

5. The device of claim 1, where in said handle is wood.

6. The device of claim 1, where in said frame is made of stainless steel.

7. The device of claim 1, where in there are six rotatable skewers.

8. The device of claim 1 where the motor assembly comprises an electric motor connected to a plurality of gears.

9. A multi-spit accessory device for grilling barbeque, comprising:
a plurality of rotisserie skewers connected to said device;
a motor assembly connected to said device for rotating said rotisserie skewers, said motor assembly slideably connected to said rotisserie skewers;
a screw for adjustable connecting said rotisserie skewers to said motor assembly.

10. The device of claim 9, wherein device has six rotisserie skewers.

11. The device of claim 9, wherein device is made of stainless steel.

12. The device of claim 9, wherein said skewers are held in place by skewer supports.

13. The device of Claim , wherein said skewers supports allow said skewers to rotate.

14. The device of claim 9, wherein said screw is manipulated to adjust the size of said device.

15. The device of claim 9, said skewers are positioned to a plurality of heights.

16. The device of claim 9, wherein said skewer is a cylinder shape.

17. The device of claim 9, wherein said skewer is made of aluminum.

18. A rotisserie cooking device for cooking food, comprising;
a holding, frame for securing a plurality of skewers;
a motor for rotating said skewers; and
adjusting poles of said holding frame slidably engageable to adjust the size of said device.

19. The device of claim 18, wherein said device is made of stainless steel.

20. The device of claim 18, wherein there are six skewers.
